(19) United States
(12) Patent Application Publication
(10) Pub. No.: US 2011/0283908 A1
(43) Pub. Date: Nov. 24, 2011

(54) High Opacity Polymer Composition for Printing Inks

(75) Inventor: Dharakumar Metla, Chalfont, PA (US)

(73) Assignee: COGNIS IP MANAGEMENT GMBH, Duesseldorf (DE)

(21) Appl. No.: 13/110,054

(22) Filed: May 18, 2011

Related U.S. Application Data
(60) Provisional application No. 61/345,640, filed on May 18, 2010.

(51) Int. Cl. B41F 33/00; C09D 11/10; C08G 18/32

(52) U.S. Cl. 101/483; 528/65; 528/56; 528/55; 524/590; 524/503

(57) ABSTRACT

High-opacity polyurethane resins are produced by polymerization of polyisocyanates with polymeric polyols and subsequent chain extension with polyamines. The resins provide high-opacity inks when formulated with white pigments, which maintain good extrusion and adhesive lamination bonding strength properties. The inks are useful in flexographic and/or gravure printing processes, particularly as back-up for laminated packaging.

### CROSS-REFERENCE TO RELATED APPLICATIONS

This application claims the benefit of priority under 35 U.S.C. §119(e) of U.S. Provisional Application No. 61/345,640, filed on May 18, 2010, the entire disclosure of which is incorporated herein by reference.

### FIELD OF THE INVENTION

The invention relates to a polyurethane resin which provides high opacity when combined with white pigments to form white printing inks, and which maintains good adhesive and extrusion lamination bond strength, as well as solubility in alcohol and/or ester solvents. The high-opacity inks are useful for printed and laminated packaging films, particularly as back-up, or background, inks.

### BACKGROUND OF THE INVENTION

Recent diversification in packaging bags and containers has required a high degree of versatility and performance for printing inks and coating agents used for the ornamentation or surface protection thereof. Such inks and coating agents should exhibit excellent adhesiveness for various kinds of plastic films, blocking resistance, and resistance to pasteurization and sterilization conditions, as well as provide attractive and esthetically pleasing finished containers and produce clear and readily recognizable product information. Especially in the field of food packaging, bags or containers made of laminated film materials are used for the reasons that they are sanitary and their contents do not come into direct contact with the ink, and also provide an esthetically pleasing appearance as a high grade printed product.

Generally there are two methods for producing such laminated film materials. One is an extrusion lamination method, wherein a plastic film substrate is printed with an ink, and if necessary, a primer is applied onto the inked surface; then a molten resin such as polyolefin is extruded onto the inked surface. Another method is an adhesive laminating method, wherein an adhesive is applied onto the inked surface of the plastic film substrate, and a plastic film is then laminated onto the same surface. Accordingly, the laminating inks must possess excellent adhesion to the printing substrate as well as to the film to be laminated.

Existing commercial polyurethane resins provide useful liquid inks for lamination packaging applications. These polyurethane resins show excellent adhesion upon lamination to numerous substrates, especially plastic films, including polyethylene terephthalate (PET), biaxially oriented polypropylene (boPP), nylon and polyolefins. Existing polyurethane resin technology also provides resins which are soluble in typical ink solvent blends such as alcohol and ester mixtures, for use in both flexographic and gravure printing applications. However, the existing commercial resins have poor opacity with white pigments.

Therefore, there continues to be a need to develop a polyurethane resin that provides high opacity when formulated into inks using white pigments, and also maintains good adhesive and extrusion lamination bond strength as well as maintaining solubility in alcohol and ester mixtures.

White inks are used as back-up (background) to colored inks in order to enhance both the colors and print quality. The higher the opacity of the background, the higher the color and print enhancement.

It is an object of the present invention to provide a high-opacity polyurethane resin that provides a high-opacity ink when formulated with a white pigment, the resin still maintaining solubility in alcohol, ester and alcohol/ester blends, as well as maintaining good adhesion to high barrier substrates, good pigment grinding characteristics, and stable rheology when incorporated into ink formulations.

### BRIEF SUMMARY OF THE INVENTION

High-opacity polyurethane resins are produced by the polymerization of polyisocyanates with polymeric polyols, optionally in the presence of a catalyst, and subsequent chain extension with polyamines. The high-opacity polyurethane resins provide excellent opacity when formulated as white inks, while also maintaining good extrusion and adhesive lamination bonding strength. Inks comprising the high-opacity polyurethane resins are useful in flexographic and/or gravure printing processes, particularly as back-up for laminated packaging.

### DETAILED DESCRIPTION OF PREFERRED EMBODIMENTS

One aspect of the invention is a high-opacity polyurethane resin which comprises the reaction product of at least one polyisocyanate and at least one polymeric polyol, optionally in the presence of a catalyst, to form an isocyanate-terminated prepolymer, which prepolymer is extended with a polyamine to form the polyurethane resin of the invention. The high-opacity binder resins provide high-opacity laminating ink formulations which are useful in flexographic and/or gravure printing processes.

In one embodiment of the invention, excess diisocyanate, preferably isophorone diisocyanate, is reacted with a polypropylene glycol or mixture of polypropylene glycols to form an isocyanate terminated prepolymer. The final polymer resin is prepared by adding the prepolymer at a controlled rate to an alcohol diamine, preferably N-aminoethyl-ethanolamine (AEEA), in an alcohol solvent, preferably ethanol, providing a polyurethane resin solution. This polyurethane resin is useful as a high-opacity pigment binder, particularly as a white pigment binder, for use in laminating ink formulations for either flexographic or gravure printing processes.

Advantages of the polyurethane resins of the invention over the known art polyurethane resins include:

Higher solids content, and

Lower viscosity of the ink formulations, thereby requiring less dilution with organic solvents in order to obtain the desired ink viscosity.

The combination of the above-cited properties provides higher opacity white inks and maintains good lamination bond strength

The term “opacity”, as used in the printing and ink-related arts, is defined as the ability to absorb or block incident light, by either transmission through a substrate or by reflection from the surface of the substrate. Opacity is typically measured as a relative value on the scale from 0 to 100 opacity units, where 0 is a completely transparent material while 100 is a completely opaque material to light. The typical instrument used for measuring opacity for printing inks is an opacimeter. An opacity value of about 55-56 is considered “typical” or “good”. Higher values are preferred. A measured opacity value of greater than 56 is considered “high” or “excellent”.

Another aspect of the invention is a method of preparing high-opacity polymer compositions for laminating inks, comprising the steps of:
(a) reacting at least one polyisocyanate with at least one polymeric polyol, optionally in the presence of a catalyst, to form an isocyanate-terminated prepolymer, and
(b) reacting said prepolymer with at least one polyamine in at least one solvent to form a binder resin,
   wherein said binder resin forms high-opacity laminating ink formulations which are used in flexographic and/or gravure printing processes.

Still another aspect of the invention is a high-opacity printing ink composition suitable for laminating applications comprising the high-opacity polyurethane resin, at least one pigment, optionally one or more organic solvents, and optionally, one or more co-resins. The high-opacity laminating inks have a measured opacity value of greater than 56, and are useful in flexographic and/or gravure printing processes, particularly laminating packaging applications. The solvents useful for preparing the high-opacity laminating inks are the same as those described below for the polyurethane resin-forming reaction. Preferred co-resins are polyvinyl butyral and/or nitrocellulose. Preferably, the pigment is a white pigment, most preferably titanium dioxide.

Accordingly, another aspect of the invention is a method of preparing a high-opacity laminating ink, comprising the steps of:

(a) providing a high-opacity binder resin prepared by the steps comprising:
(i) reacting at least one polyisocyanate with at least one polymeric polyol, optionally in the presence of a catalyst, to form an isocyanate-terminated prepolymer, and
(ii) reacting said prepolymer with at least one polyamine in at least one solvent to form a binder resin,

(b) adding at least one white pigment,

(c) optionally, adding one or more organic solvents, and

(d) optionally, adding one or more co-resins,

wherein said high-opacity laminating ink is useful in flexographic and/or gravure printing processes.

Accordingly, yet another aspect of the invention is a method of providing a high-opacity back-up for laminated packaging comprising the step of flexographic printing or gravure printing using the above high-opacity laminating ink, particularly a high-opacity laminating ink comprising a white pigment.

The high-opacity polyurethane resin of the invention is soluble in an organic solvent, such as alcohols, esters and alcohol/ester blends, and is particularly useful in formulating high-opacity laminating inks for packaging applications. The solubility of the resin in alcohol, ester and alcohol/ester blends allows formulation of ink and/or coating compositions which are useful for flexographic and gravure printing applications.

Laminating ink and coating compositions formed with the polyurethane resin of the invention exhibit excellent extrusion lamination bond strengths, block resistance, printability, resolubility, and superior adhesion on a wide variety of films, as compared to laminating inks and coatings made with conventional and commercially available polyurethane resin binder systems.

In one embodiment, the polyurethane resin is prepared by reacting an aliphatic, cycloaliphatic, aromatic or alkylaromatic diisocyanate with a polymeric polyol to provide an isocyanate-terminated polyurethane prepolymer. The prepolymer is then chain extended using a diamine to form urea linkages. Typically, the resulting polyurethane resin has a number average molecular weight of from about 1000 to about 100000 Daltons, preferably from about 1000 to about 50000.

A diisocyanate of the formula, OCN—Z—NCO, wherein Z is an aliphatic, cycloaliphatic, aromatic, or alkylaromatic group, can be reacted with a polymeric polyol such as a polyether diol, a polyester diol, or combinations thereof to prepare the isocyanate-terminated polyurethane prepolymer. Examples of suitable diisocyanates include, but are not limited to 1,4-diisocyanatobutane, 1,6-diisocyanatohexane, 1,5-diisocyanato-2,2-dimethylpentane, 2,2,4- or 2,4,4-trimethyl-1,6-diisocyanatohexane, 1,10-diisocyanatodecane, 1,3- and 1,4-diiso-cyanatocyclo-hexane, 1-isocyanato-5-isocyanatomethyl-3,3,5-trimethylcyclohexane (isophorone diisocyanate), 2,3-, 2,4- and 2,6-diisocyanato-1-methylcyclohexane, 4,4′- and 2,4′-diisocyanatodicyclohexylmethane, 1-isocyanato-3(4)-isocyanatomethyl-1-methyl-cyclohexane, 2,4-, and 2,5- and 2,6-tolylene diisocyanate, 1,3- and 1,4-phenylene diisocyanate, 4,4′- and 2,4′-diisocyanatodiphenylmethane, 1,3-bis(1-isocyanato-1-methylethyl)benzene, dimer diisocyanate and mixtures thereof. Preferred is isophorone diisocyanate.

Suitable polymeric polyols include one or more polyether diols, one or more polyester diols, and mixtures thereof.

Suitable polyether diols include those represented by the formula:

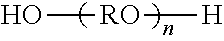

wherein R is a hydrocarbon group, preferably an alkylene group, with 2 to 8 carbon atoms which may be linear or branched, with n=2 to about 200, preferably about 9 to about 150, more preferably about 10 to about 100, still more preferably about 17 to about 43, and most preferably about 21 to about 35. Preferably, R is a C₂ to C₄ alkylene group. Examples of particularly useful polyether diols include, but are not limited to, polyethylene glycols, polypropylene glycols and polytetramethylene glycols, with polypropylene glycols being preferred. The number average molecular weight of the polyether diols typically ranges from about 500 to about 5000, preferably from about 1000 to about 2500. The polyether diols can also contain a minor percentage by weight, e.g., up to about 40 weight percent, of ester units. These diols can be obtained, e.g., by reacting one or more of the aforesaid polyether diols with a lactone such as ε-caprolactone.

Useful polyester diols include those represented by the formula:

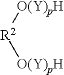

wherein
R² is the residue of a diol HO—R²—OH, wherein R² is a linear or branched alkylene group with 2 to 8 carbon atoms,
Y is —C(═O)—R³—C(═O)O—R²—O— in which R² is defined as above, and R³ is the residue of a dicarboxylic acid HOOC—R³—COOH or anhydride thereof, wherein R³ is a linear or branched alkylene group with 2 to 8 carbon atoms, or Y is —C(═O)—R³—O—, in which R³ is the residue of a lactone or an α,ω-hydroxycarboxylic acid HO—R³—COOH, and R³ is defined as above; and
p and q independently are numbers from 0 to 600, preferably from 1 to 100, provided that the sum of p+q is from 1 to 1200, preferably from 1 to 250.

Suitable diols HO—R²—OH, carboxylic acids HOOC—R³—, anhydrides, lactones and α,ω-hydroxycarboxylic acids HO—R³—COOH include any of those known for preparing polyester diols. Examples of diols include, but are not limited to, ethylene glycol, propylene glycol, 1,4-butanediol, neopentyldiol, hexanediol, diethylene glycol, dipropylene glycol, and the like. Suitable dicarboxylic acids and anhydrides include, but are not limited to, adipic acid, phthalic acid, dimerized fatty acids (dimer acids), phthalic anhydride, and the like. Suitable lactones and α,ω-hydroxycarboxylic acids include butyrolactone, caprolactone, α,ω-hydroxycaproic acid, and the like. Examples of particularly useful polyester diols include, but are not limited to, poly(caprolactone) diols, poly(diethylene glycol-co-ortho-phthalic acids), poly(1,6-hexanediol-co-ortho-phthalic acids), poly(neopentyl glycol-co-adipic acids), and poly(ethylene glycol-co-adipic acids). The number average molecular weight of the polyester diol typically ranges from 500 to 5000, preferably from 500 to 2500, and more preferably from 1000 to 2000. The polyester diols can also contain ether units. In a preferred embodiment the polyester diols contain ether units in an amount of up to about 40% by weight. These diols can be obtained, e.g., by reacting one or more of the aforesaid polyester diols with one or more 1,2-alkylene oxides such as ethylene oxide, propylene oxide, etc.

Polyether diols are desirable in terms of the product polyurethane resin having greater solubility in aliphatic alcohol solvents compared with polyester diols. However, polyester diols impart greater tensile strength to the resin. Therefore, depending on the choice of polymeric diol, the polyurethane resin obtained in accordance with the invention can vary from those resins possessing high solubility and relatively low tensile strength, i.e., those made entirely from polyether diol to those of relatively low solubility and relatively high tensile strength made entirely from polyester diol, and all of the combinations of solubility and tensile strength properties in between as would be the case where mixtures of polyether and polyester diols are employed.

In one embodiment, the polymeric polyol and diisocyanate are reacted under conditions which are known to those skilled in the art. Preferably, the reaction is carried out in the presence of at least one organic solvent, which is preferably the same as that typically used in the compositions formulated using the resin, such as the solvent system of an ink formulation. Examples of suitable solvents in which the diisocyanate and polymeric polyol can be reacted include, but are not limited to lower alkyl (1-6 carbon) esters of C1-C6 carboxylic acids, preferably C1-C6 esters of C2-C6 carboxylic acids, particularly C1-C6 acetates or propionates, such as methyl acetate, ethyl acetate, propyl acetate, butyl acetate, pentyl acetate, hexyl acetate, methyl propionate, ethyl propionate, propyl propionate, butyl propionate, pentyl propionate and hexyl propionate. C1-C6 alcohols are also suitable reaction solvents, with ethanol, 1-propanol and 2-propanol being particularly preferred. Also particularly preferred are combinations of C1-C6 alcohols with C1-C6 esters of C2-C6 carboxylic acids, such as ethanol/ethyl acetate and propanol/propyl acetate. Any of the above C3-C6 alcohols and esters of C3-C6 carboxylic acids can have linear or branched alkyl moieties, which also may be saturated or unsaturated.

Optionally, the above-indicated reaction of polyisocyanate and polymeric polyol is catalyzed by a metal catalyst, preferably comprising bismuth, zinc, zirconium, or combinations thereof. Most preferably, the catalyst comprises bismuth and/or zinc carboxylates. One such commercially available catalyst is BiCat® 8, a bismuth/zinc carboxylate catalyst blend from Shepherd Chemical.

The ratio of diisocyanate to polymeric polyol is selected to obtain a desired molecular weight as well as a desired level of urethane and urea segments. An excess of diisocyanate is used to ensure that the prepolymer is terminated with at least one isocyanate group. The equivalent ratio of diisocyanate to diol generally ranges from 1.2-5.0 to 1, preferably 2 to 1.

The total amount of solvent used for preparation of the isocyanate-terminated prepolymer typically ranges from 0 to 95 percent by weight of the total solution

Formation of the isocyanate-terminated prepolymer is generally carried out at a temperature in the range of about 0 to about 130° C., preferably in the range of about 50 to about 90° C.

The isocyanate-terminated prepolymer is then chain extended with a polyamine or a polyaminoalcohol, preferably a diamine or diaminoalcohol, to form the polyurethane resin. The diamine can be any aliphatic, cycloaliphatic, aromatic, or heterocyclic diamine in which each of the amine groups possesses at least one labile hydrogen atom. Suitable diamines include, but are not limited to, ethylene diamine, 1,2-diaminopropane, 1,3-diaminopropane, hydrazine, diaminobutane, hexamethylene diamine, 1,4-diaminocyclohexane, 3-aminomethyl-3,5,5-trimethylcyclohexylamine (isophorone diamine), 1,3-bis(aminomethyl)cyclohexane, 1,3-bis(aminomethyl)benzene, 2-(aminomethyl)-3,3,5-trimethylcyclopentylamine, bis-(4-aminocyclo-hexyl)-methane, bis-(4-amino-3-methylcyclohexyl)-methane, 1-amino-1-methyl-3(4)-aminomethyl-cyclohexane, bis-(4-amino-3,5-diethylcyclohexyl)-methane, bis-amino-methyl-hexahydro-4,7-methanoindane, 2,3-, 2,4- and 2,6-diamino-1-methyl-cyclohexane, dimer diamine (diamine from dimerized fatty acids), norbornane diamine, 2,2,4- and 2,4,4-trimethyl-1,6-hexanediamine, DuPont brand Dytek™ A and Dytek™ EB, Huntsman's Jeffamine™ brand bis(propylamino) polypropylene oxide diamines, bis(aminomethyl)tricyclodecane, piperazine, 1,3-di-piperidylpropane, aminoethylpiperazine. N-aminoethyl-ethanolamine is preferred. Suitable polyaminoalcohols include, but are not limited to, N-aminoethyl-ethanolamine, N—aminoethyl-propanolamine, N-aminopropyl-ethanolamine, and N-aminopropyl-propanolamine. N-aminoethyl-ethanolamine is particularly preferred.

The conditions under which the diamine is reacted with the prepolymer are known to those skilled in the art. Preferably, the reaction is carried out in the solvent or in at least one component of the solvent system ultimately used in the final ink formulation, as discussed above. The amount of solvent utilized in the chain extension reaction generally ranges from 0 to 90 percent by weight, and preferably from 35 to 60 percent by weight. The ratio of isocyanate end groups of the prepolymer to amines from the diamine determines the final polymer molecular weight of the resin as well as the level of urea groups. Generally the mole ratio of diisocyanate to diamine is from 6:1 to 1:5, preferably from 4:1 to 1:4. Typically, when the prepolymer is reacted with a stoichiometric excess of the diamine, no residual unreacted isocyanate groups remain in the prepolymer. Accordingly, reaction of the chain-extended prepolymer with an amine or alcohol terminating agent to endcap unreacted isocyanate groups on the chain-extended prepolymer is not required. However, if less than a stoichiometric excess of diamine is utilized, unreacted isocyanate groups may be present which can be endcapped as described below. The chain extension reaction with diamine is generally carried out at a temperature in the range of about 0 to about 90° C., and preferably in the range of about 25 to about 75° C.

For chain extension of the prepolymer, the preferred solvent is ethanol.

Following the chain extension reaction with polyamine, some or all of any remaining isocyanate groups may be endcapped with an amine or alcohol to terminate the poly(urethane-urea) resin. Preferably, all remaining isocyanate groups are endcapped. Examples of suitable endcapping amines are monoamines and diamines including, but not limited to butylamine, dibutylamine, aminopropylmorpholine, aminoethylpiperazine, dimethylaminopropylamine, di(isopropanol)amine, aminoethoxyethanol, aminoundecanoic acid, ethanolamine, dimethanolamine, 4-aminophenol, isophoronediamine, dimer diamine, oleyl amine, hydrazine, and Jeffamine®-type mono- or bis-(aminopropyl) polypropyleneoxides. Examples of suitable endcapping alcohols include, but are not limited to, 1-propanol, 2-propanol, 1-butanol, 2-butanol, neopentyl alcohol, ethanol, oleyl alcohol, 12-hydroxystearic acid, N-(hydroxyethyl)stearamide, ethoxylated nonylphenol, propoxylated nonylphenol, glycolic acid, and 6-hydroxycaproic acid.

The endcapping reaction of any remaining free isocyanate groups is carried out under conditions which are known to those skilled in the art. Preferably, this reaction is carried out in the presence of a solvent or in a component of the solvent system ultimately used in the final composition formulated from the ink resin, as described above. The total amount of solvent utilized to endcap the free isocyanate groups generally ranges from 0 to 90 percent by weight, and preferably ranges from 25 to 75 percent by weight.

The endcapping reaction is generally performed at a temperature of about 0 to about 100° C., and preferably at a temperature of about 25 to about 75° C. The NCO-equivalent ratio of the chain-extended resin to amine or alcohol generally ranges from 5:1 to 1:5, and preferably ranges from 1:2 to 2:1.

The high-opacity polyurethane binder resins of the present invention, when used to make ink compositions, impart the advantage of maintaining the high bond strengths of the laminated structures. Thus, the high-opacity resins and inks of the invention are particularly useful as back-up, or background which enhances other printing, especially for laminated packaging applications.

By virtue of the high-opacity polyurethane resins maintaining a high lamination bond strength, a laminate printed with an ink composition containing the high-opacity polyurethane resin of this invention as a binder advantageously maintains both its printed image and structural integrity, i.e., the laminate remains substantially free of delamination-related defects.

The term “high lamination bond strength” shall be understood to encompass those polyurethane resins exhibiting lamination bond strength of greater than 200 g/inch when peeled at 300 mm/min.

The high-opacity laminating ink composition of the invention comprises the polyurethane resin of the invention, a white pigment, a co-resin and an organic solvent or mixture of organic solvents. The high-opacity ink composition of the invention may be used in either flexographic or gravure printing. In particular, the ink of the invention comprises, based on the weight of the ink: 10 wt. % to 50 wt. % of the polyurethane resin, 6 wt. % to 50 wt. % of the pigment, 0 wt % to 10 wt % of co-resin, and 10 wt. % to 80 wt. % of the organic solvent, where component concentrations may be adjusted for use in flexographic or gravure printing. Preferably, the gravure ink comprises 8 wt. % to 60 wt. % of the polyurethane resin, 3 wt. % to 50 wt. % of the pigment, 0 wt % to 10 wt % of co-resin, and 10 wt. % to 80 wt. % of the organic solvent such as alkyl ester solvent; and the flexographic ink comprises, 8 wt. % to 60 wt. % of the polyurethane resin, 3 wt. % to 50 wt. % of the pigment, 0 wt % to 10 wt % of co-resin, and 10 wt. % to 80 wt. % of the organic solvent such as an alcohol solvent. The ink of this invention has a viscosity between 15 seconds to 30 seconds, as measured in a Zahn 2 efflux cup. The efflux cup measurement is a conventional method for measuring ink viscosity, and involves timing the flow of a calibrated quantity of ink through a calibrated orifice. The lower viscosity inks typically are used in gravure printing and the higher viscosity inks typically are used in flexographic printing. Thus, when the ink has a viscosity of 28 seconds as measured in a Zahn 2 efflux cup, it is suitable for flexographic printing; and when the ink has a viscosity of 18 seconds as measured in a Zahn 2 efflux cup, it is suitable for gravure printing applications.

The preferred solvent for flexographic printing inks is 80:20 alcohol:acetate ester, preferably ethanol:ethyl acetate. The preferred solvent for gravure printing inks is 20:80 alcohol:acetate, preferably ethanol:ethyl acetate.

Another aspect of the invention relates to the printing of the high-opacity laminating ink image-wise onto a surface of a polymeric substrate and forming a dried ink image on a surface of the substrate. The image formed is tack-free, firmly adherent to the surface of the substrate, and undergoes no picking, blocking or decaling when contacted under pressure at ambient temperatures to a second surface of the same or another substrate. Although any polymeric substrate may be printed with this method, preferred polymeric substrates include polyethylene (PE), polypropylene (PP), preferably biaxially oriented polypropylene (boPP), polyethylene terephthalate (PET), cellulose acetate, cellulose acetate butyrate, polycarbonate (PC), polyamide (PA), PVDC coated polyethylene terephthalate, PVDC coated polypropylene, metallized polyethylene terephthalate, metallized polypropylene, and other barrier films. Particularly preferred film substrates used for lamination are PET, boPP, PA, silicon dioxide-coated PET, PA and PP and aluminum oxide-coated PET, PA and PP films.

A second substrate or a multilayered laminated structure may be laminated to the dried ink image on the first substrate by any conventional method to form a printed laminate. Thus, the second substrate may be applied as an extruded melt onto the dried image to form the second substrate; alternatively, a preformed second substrate or a combination of films may be laminated to the dried ink image through an adhesive surface. The second substrate or a combination of films may be composed of the same material as the first substrate or it may be different depending on the nature of the end use of the printed laminate.

In general, at least one of the substrates will be translucent to visible light and, more typically, transparent. Such transparency or translucency will allow the pigment to present a distinct hue and/or resolvable image through the substrate. This will also allow the high-opacity white back-up layer to be clearly visible through the transparent or translucent substrate.

Those skilled in the art will appreciate that the foregoing detailed description of preferred embodiments, and the following Examples are illustrative of the present invention, and do not necessarily limit the scope thereof.

### EXAMPLES

### Test methods

### Printing

A 165P hand proofer from Pamarco was used to print inks onto the films (boPP or PET).

### Tape Adhesion Test

The tape Scotch® 610 from 3M was applied immediately after the prints were dried, then peeled off.

The following rating system was used:
0%=poor ink adhesion, with 100% ink coming off of the substrate
100%=excellent ink adhesion, with 0% ink coming off of the substrate

### Block Resistance Test

Prints were folded to have ink/back and ink/ink contact.

Folded prints were subjected to the following conditions in an oven:
52° C./2.8 bar/24 h (which corresponds to 125° F./40 psi/24 h)

The following rating system was used:
1=poor block resistance, with 100% ink transfer from the print side
10=excellent block resistance, with 0% ink transfer from the print side

### Adhesive Lamination

Laminate structure (example): film/ink/adhesive/film

Adhesive applied per manufacturer's recommendation.

Lamination conditions: 79° C./1.438 bar/1 sec (corresponding to 175° F./20 psi/1 sec) using a CARD/GUARD® laminator from Jackson-Hirsh Laminating.

Adhesives were applied on the printed film. The coating weight and cure conditions were followed according to the adhesive manufacturer's recommendations.

### Bond Strength Test

Thwing Albert Friction/Peel tester Model 225-1 was used to measure bond strength of the laminates, prints were supported with tape and peeled at 180° angle with 300 mm/min speed. Values are the average of 3 readings, in grams/inch.

Destruct=complete film tear during peel
FT=partial film tear during peel
Decal: 100%=all ink coming off of the printed film during peel
0%=no ink coming off of the printed film during peel

### Starting Materials

Vestinat® IPDI, isophorone diisocyanate, from Degussa
Pluriol® P 1000, polypropylene glycol (Mn=1000), from BASF
Pluriol® P 2000, polypropylene glycol (Mn=2000), from BASF
BiCat® 8, bismuth/zinc carboxylate catalyst blend, from Shepherd Chemical
Versamid® PUR 1011, commercial polyurethane resin from Cognis
Versamid® PUR 2011, commercial polyurethane resin from Cognis
NeoRez® U-395, commercial polyurethane resin from DSM-NeoResins
TR 50, titanium dioxide pigment, from Huntsman
T523-3, 75 gauge corona pre-treated biaxially oriented polypropylene (boPP) film, from AET Films
Mylar® 48LBT, 48 gauge corona pre-treated polyethylene terephthalate (PET), from DuPont
Adcote® 331=1-component polyurethane adhesive from Rohm & Haas
Adcote® 812/Adcote® 811 B=2-component polyurethane adhesive from Rohm & Haas
PVB=BN® 18 polyvinyl butyral from Wacker

### Polyurethane Examples

### Example Resin 1

A mixture of 18.08% by weight, based on the final polyurethane resin solution, of Vestinat® IPDI (Degussa), 36.93% Pluriol® P 1000 (BASF) and 8.39% Pluriol® P 2000 (BASF) was reacted in the presence of 0.02% BiCAT® 8 (Shephard Chemical) catalyst at 65-70° C. for 2 hours under nitrogen flow, monitoring the reaction until the percentage of unreacted isocyanate groups was 5.3%. This resulted in an isocyanate-terminated prepolymer, having a Brookfield viscosity of 12,800 cps at 25° C.

The final polyurethane resin solution was prepared by adding the above prepolymer at a controlled rate to 6.07% by weight, based on the final polyurethane resin solution, of N-aminoethyl-ethanolamine in 30.5%, based on the final polyurethane resin solution, of ethanol.

The final polyurethane solution has a Brookfield viscosity of 2560 cps at 25° C., a solids content of 71.03% and a Gardner color index of less than 2.

### Example Inks

Ink formulations were prepared by combining the components (% by weight) as disclosed in Table 1.

TABLE 1
Ink Formulations, % by weight

| | Versamid ® | Versamid ® | Example | NeoRez ® |
|---|---|---|---|---|
| Component | PUR 1011 | PUR 2011 | Resin 1 | U-395 |
| Versamid ® PUR 1011 | 28.00 | — | — | — |
| Versamid ® PUR 2011 | — | 28.00 | — | — |
| Example Resin 1 | — | — | 14.00 | — |
| NeoRez ® U 395 | — | — | — | 20.85 |
| PVB (white ink), 30% | 4.00 | 4.00 | 4.00 | 4.00 |
| in 1-PrOH/PrAc (1) | | | | |
| TR 50 | 46.00 | 46.00 | 46.00 | 46.00 |
| white pigment | | | | |
| 80/20 | 22.00 | 22.00 | 36.00 | 29.15 |
| 1-PrOH/PrAc | | | | |
| Total | 100.00 | 100.00 | 100.00 | 100.00 |

(1) PrAc is propyl acetate.

### Performance Examples

### Performance Example 1

White inks were prepared according to Table 1 and printed onto either boPP or PET films. The opacity was measured according to each instrument manufacturer's directions. Results are collected in Table 2.

TABLE 2
Opacity Results

| Instrument | Film (with | Ink containing | Ink containing | Ink containing | Ink containing |
|---|---|---|---|---|---|
| measuring | white ink | Versamid ® | Versamid ® | Example | NeoRez ® |
| opacity | printed) | PUR 1011 (1) | PUR 2011 (1) | Resin 1 | U-395 (2) |
| Datacolor (5) | boPP (3) | 67.6 | 69.0 | 70.7 | 69.9 |
| Technidyne (6) | boPP | 56.3 | 57.4 | 60.7 | 58.0 |
| X-Rite (7) | boPP | 60.1 | 61.0 | 65.0 | 62.3 |
| Datacolor | PET (4) | 67.9 | 68.6 | 70.0 | 68.5 |
| Technidyne | PET | 57.2 | 58.0 | 60.0 | 58.7 |
| X-Rite | PET | 61.1 | 61.1 | 65.1 | 62.6 |
| Average opacity (8) | | 61.7 | 62.5 | 65.2 | 63.3 |

(1) Versamid ® PUR 1011 and Versamid ® PUR 2011 from Cognis Corp
(2) NeoRez ® U-395 from DSM-NeoResins
(3) T 523/3 boPP, biaxially oriented polypropylene film from AET Corp
(4) 48LBT PET, polyethylene terephthalate film from DuPont Corp
(5) Spectraflash ® 600 Plus from Datacolor International
(6) Opacimeter model BNL-3 from Technidyne
(7) SpectroDensitometer ® model 530 from X-Rite
(8) average value of opacity over all 3 instruments and 2 different plastic film types (n = 6)

As is evident from the data in Table 2, the ink prepared from Example Resin 1 of the invention clearly had higher opacity when compared with inks prepared from the commercially available binder resins, both in terms of individual measurements on the same instrument for each film type, and as an aggregate average value across all instruments and film types.

TABLE 3
Lamination Results (bond strengths in grams/inch)

| | Film (with white | Versamid ® | Versamid ® | Example | NeoRez ® |
|---|---|---|---|---|---|
| Test | ink printed) | PUR 1011 (1) | PUR 2011 (1) | Resin 1 | U-395 (2) |
| Scotch ® 610 tape | boPP (3) | 100% | 100% | 40% | 40% |
| adhesion | | | | | |
| Adcote ® 331 (5) | boPP | 514 FT (7) | destruct | destruct | destruct |
| laminate bond | | | | | |
| strength (with tape) | | | | | |
| Decal, % | boPP | 100% | | | |
| Adcote ® 812-811B | boPP | destruct | destruct | destruct | 403 |
| (6) laminate bond | | | | | |
| strength (with tape) | | | | | |
| Decal, % | boPP | | | | 100% |
| Block resistance, | boPP | 10 | 10 | 10 | 10 |
| ink-back | | | | | |
| Block resistance, | boPP | 10 | 10 | 10 | 10 |
| ink-ink | | | | | |
| Scotch ® 610 tape | PET (4) | 100% | 100% | 40% | 40% |
| adhesion | | | | | |
| Adcote ® 331 | PET | 100 | 101 | 155 | 47 |
| laminate bond | | | | | |
| strength (with tape) | | | | | |
| Decal, % | PET | 90% | 90% | 90% | 100% |
| Adcote ® 812-811B | PET | 71 | 87 | 95 | 67 |
| laminate bond | | | | | |
| strength (with tape) | | | | | |
| Decal, % | PET | 100% | 100% | 100% | 100% |
| Block resistance, | PET | 10 | 10 | 10 | 10 |
| ink-back | | | | | |
| Block resistance, | PET | 10 | 10 | 10 | 10 |
| ink-ink | | | | | |

(1) Versamid ® PUR 1011 and Versamid ® PUR 2011 from Cognis Corp
(2) NeoRez ® U-395 from DSM-NeoResins
(3) T 523/3 boPP, biaxially oriented polypropylene film from AET Corp
(4) 48LBT PET, polyethylene terephthalate film from DuPont Corp
(5) Adcote ® 311 from Rohm & Haas
(6) Adcote ® 812-811B from Rohm & Haas
(7) FT = f ilm tear

As can be seen from the bond strength data in Table 3, for laminate structures prepared using the inks of Table 1 comprising the indicated resins, the lamination bond strength of the polyurethane of the invention is higher than the commercial polyurethane resins, thus providing a laminate substantially free of delamination defects while also maintaining the integrity of the printed image.

What is claimed is:

1. A high-opacity polymer composition comprising a high-opacity binder resin prepared by a process comprising the steps of:
(a) reacting at least one polyisocyanate with at least one polymeric polyol, optionally in the presence of a catalyst, to form an isocyanate-terminated prepolymer, and
(b) reacting said prepolymer with at least one polyamine in at least one solvent to form a binder resin,
wherein said binder resin forms high-opacity laminating ink formulations which are used in flexographic and/or gravure printing processes.

2. The high-opacity polymer composition of claim 1, wherein said polyisocyanate comprises a diisocyanate selected from the group consisting of 1,4-diisocyanatobutane; 1,6-diisocyanatohexane; 1,5-diisocyanato-2,2-dimethylpentane; 2,2,4-trimethyl-1,6-diisocyanatohexane; 2,4,4-trimethyl-1,6-diisocyanatohexane; 1,10-diisocyanatodecane; 1,3-diisocyanatocyclohexane; 1,4-diisocyanatocyclo-hexane; 1-isocyanato-5-isocyanatomethyl-3,3,5-trimethylcyclohexane (isophorone diisocyanate); 2,3-diisocyanato-1-methylcyclohexane; 2,4-diisocyanato-1-methylcyclohexane; 2,6-diisocyanato-1-methylcyclohexane; 4,4′-diisocyanatodicyclohexylmethane; 2,4′-diisocyanatodicyclohexylmethane; 1-isocyanato-3(4)-isocyanatomethyl-1-methyl-cyclohexane; 2,4-toluene diisocyanate; 2,5-toluene diisocyanate; 2,6-toluene diisocyanate; 1,3-phenylene diisocyanate; 1,4-phenylene diisocyanate; 4,4′-diisocyanatodiphenylmethane; 2,4′-diisocyanatodiphenylmethane; 1,3-bis(1-isocyanato-1-methylethyl)benzene; dimer diisocyanate; and combinations thereof.

3. The high-opacity polymer composition of claim 2, wherein said diisocyanate comprises isophorone diisocyanate.

4. The high-opacity polymer composition of claim 1, wherein said polymeric polyol comprises one or more polyether diols of the formula: 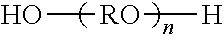
wherein R is a C₂ to C₈ straight chain or branched hydrocarbon group, and n=2 to about 200.

5. The high-opacity polymer composition of claim 4, wherein said polymeric polyol comprises polypropylene glycol.

6. The high-opacity polymer composition of claim 5, wherein said polypropylene glycol has a molecular weight range of from about 500 to about 5000.

7. The high-opacity polymer composition of claim 1, wherein said catalyst is present, and comprises a metal selected from the group consisting of bismuth, zinc, zirconium, and combinations thereof.

8. The high-opacity polymer composition of claim 1, wherein said polyamine comprises a polyaminoalcohol.

9. The high-opacity polymer composition of claim 8, wherein said polyaminoalcohol comprises N-aminoethyl-ethanolamine.

10. The high-opacity polymer composition of claim 1, wherein said solvent comprises alcohols and/or alkyl esters.

11. The high-opacity polymer composition of claim 10, wherein said solvent is selected from the group consisting of C1-C6 alcohols, C1-C6 esters of C2-C6 carboxylic acids, and combinations thereof.

12. The high-opacity polymer composition of claim 11, wherein said solvent is selected from the group consisting of ethanol, 1-propanol, 2-propanol, ethyl acetate, n-propyl acetate, i-propyl acetate and mixtures thereof.

13. The high-opacity polymer composition of claim 1, wherein said polyisocyanate and said polymeric polyol are reacted in a mole ratio of about 1.2-5 to 1.

14. A high-opacity laminating ink comprising:
(a) the high-opacity polymer composition of claim 1,
(b) at least one pigment,
(c) optionally, one or more organic solvents, and
(d) optionally, one or more co-resins,
wherein said laminating ink has a measured opacity value of greater than 56, and is used in flexographic and/or gravure printing processes.

15. The high-opacity laminating ink of claim 14, wherein said pigment is a white pigment.

16. The high-opacity laminating ink of claim 15, wherein said white pigment comprises titanium dioxide.

17. A method of providing a high-opacity back-up for laminated packaging comprising the step of flexographic printing or gravure printing using the high-opacity laminating ink of claim 15.

18. The high-opacity laminating ink of claim 14, wherein said co-resin is present and comprises polyvinyl butyral.

19. The high-opacity polymer composition of claim 1, wherein said polymeric polyol comprises one or more polyester diols of the formula: 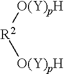
wherein
R² the residue of a diol HO—R²—OH, wherein R² is a linear or branched alkylene group with 2 to 8 carbon atoms,
Y is —C(═O)—R³—C(═O)O—R²—O— in which R² is defined as above, and R³ is the residue of a dicarboxylic acid HOOC—R³—COOH or anhydride thereof, wherein R³ is a linear or branched alkylene group with 2 to 8 carbon atoms, or Y is —C(═O)—R³—O—, in which R³ is the residue of a lactone or an α,ω-hydroxycarboxylic acid HO—R³—COOH, and R³ is defined as above; and
p and q independently are numbers from 0 to 600, provided that the sum of p+q is from 1 to 1200.

20. The high-opacity polymer composition of claim 1 wherein said polyamine comprises at least one diamine selected from the group consisting of ethylene diamine, 1,2-diaminopropane, 1,3-diaminopropane, hydrazine, diaminobutane, hexamethylene diamine, 1,4-diaminocyclohexane, 3-aminomethyl-3,5,5-trimethylcyclohexylamine (isophorone diamine), 1,3-bis(aminomethyl)cyclohexane, 1,3 bis(aminomethyl)benzene, 2-(aminomethyl)-3,3,5-trimethylcyclopentylamine, bis-(4-aminocyclo-hexyl)-methane, bis-(4-amino-3-methylcyclohexyl)-methane, 1-amino-1-methyl-3(4)-aminomethyl-cyclohexane, bis-(4-amino-3,5-diethylcyclohexyl)-methane, bis-amino-methyl-hexahydro-4,7-methanoindane, 2,3-, 2,4- and 2,6-diamino-1-methyl-cyclohexane, dimer diamine, norbornane diamine, 2,2,4- and 2,4,4-trimethyl-1,6-hexanediamine, bis(propylamino) polypropylene oxide diamine, bis(aminomethyl)tricyclodecane, piperazine, 1,3-di-piperidylpropane, aminoethylpiperazine and mixtures thereof.
